(19) United States
(12) Patent Application Publication
(10) Pub. No.: US 2008/0122834 A1
(43) Pub. Date: May 29, 2008

(54) 3D LINE OF SIGHT (LOS) ANALYSIS OF 3D VERTICAL BARRIERS IN 3D VIRTUAL REALITY ENVIRONMENTS

(76) Inventor: Dror Ouzana, Haifa (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/563,744

(22) Filed: Nov. 28, 2006

(30) Foreign Application Priority Data
Nov. 28, 2006 (IL) 172217

(51) Int. Cl. G06T 15/00

(52) U.S. Cl. 345/419

(57) ABSTRACT

A method for 3D line-of-sight (LOS) visualization in a user interactive 3D virtual reality environment includes the following steps: a) displaying a 3D virtual reality scene; b) determining a 3D LOS between a pair of user determined spaced apart nodes placed on the 3D virtual reality scene, wherein the 3D LOS includes at least one unobstructed 3D LOS segment; and c) displaying the at least one unobstructed 3D LOS segment on the 3D virtual reality scene.

### FIELD OF THE INVENTION

The invention pertains to simulations in 3D virtual reality environments.

### BACKGROUND OF THE INVENTION

Vertical barriers can be made from a wide range of materials including concrete, metallic materials, plastic materials, glass materials, and the like, for serving a wide range of civil engineering applications, homeland security applications, military applications, and the like.

U.S. Pat. No. 6,902,149 to Piron illustrates and describes a vertical barrier in the form of a series of vertical towers for protecting a vulnerable target from critical damage being inflicted by the impact of a predetermined group of aircraft. Factors taken into account in the design of the towers include inter alia the distance between the target and the towers, aircraft wingspan, smallest vertical approach angle, and the like.

### SUMMARY OF THE INVENTION

Generally speaking, the present invention is directed toward a Decision Support Tool (DST) for 3D line-of-sight (LOS) analysis of existing or proposed 3D vertical barriers in 3D virtual reality environments for use in a wide range of civil engineering applications, military applications, homeland security applications, and the like. The 3D LOS analysis is applicable to relatively short vertical barriers, say, a few meters long to protect a speaker on a podium, medium length vertical barriers, say, a few kilometers long for protecting a building, a compound, and the like, and long vertical barriers of tens or even hundreds of kilometers, say, along an international border. 3D vertical barriers extend from ground level upwards for most applications but certain applications involve 3D vertical barriers suspended from above, standing on struts, and the like. The DST readily facilitates 3D LOS analysis of 3D vertical barriers under different conditions and at alternative locations in the case of a proposed vertical barrier.

For the purpose of the present invention, a 3D LOS is a 3D vector between a pair of user determined spaced apart nodes placed on a 3D virtual reality scene whilst a 3D vertical barrier coincides with an imaginary vertical plane. A 3D LOS is preferably determined by so-called ray tracing which involves extrapolating an infinite ray from a start position in 3D space along a 3D vector. A 3D LOS can be constituted by either a single continuous unobstructed 3D LOS segment or a single continuous obstructed LOS segment. Alternatively, a 3D LOS can be constituted by at least one unobstructed 3D LOS segment and at least one obstructed LOS segment therealong. The 3D changeover coordinates along a 3D LOS between an unobstructed 3D LOS segment and an obstructed 3D LOS segment can be determined by several techniques inter alia the intersection of a ray with a 3D geometric object, the use of a so-called z-Buffer, and the like. Obstructed 3D LOS segments are preferably visually displayed on a 3D virtual reality scene in a visually distinguishable manner from unobstructed 3D LOS segments.

Users employ input devices, for example, a computer mouse, a touch pad, and the like, or enter coordinates in text fields to locate a 3D vertical barrier on a selected 3D virtual reality scene, and at least one 3D point of interest on each side of the 3D vertical barrier. Users may locate single 3D points of interest on one or both sides of a 3D vertical barrier, lines of 3D points of interest on one or both sides of a 3D vertical barrier, or arrays of 3D points of interest on one or both sides of a 3D vertical barrier. Exemplary single 3D points of interest include inter alia a balcony, a lookout position, an assassination target, and the like. Exemplary lines of 3D points of interest include inter alia roads, railway tracks, airport runways, and the like. Exemplary arrays of 3D points of interest include inter alia settlements, army bases, and the like. Alternatively, 3D points of interest can be automatically generated.

The DST determines 3D lines of sight between pairs of 3D points of interest on opposite sides of a 3D vertical barrier on a 3D virtual reality scene, and height coordinates of 3D intersection points between 3D lines of sight and 3D vertical barriers. The number of 3D lines of sight ranges from a single 3D line of sight in the case of two single 3D points of interest on opposite sides of a 3D vertical barrier to m×n 3D lines of sight in the case of a m 3D points of interest and n 3D points of interest on opposite sides of a 3D vertical barrier. The DST preferably enables users to enter information particularly relevant to the design of proposed 3D vertical barriers for determining its Cartesian coordinates including its X and Y placement coordinates and its X height coordinates therealong. Such information includes inter alia the division of a 3D vertical barrier into a series of individual contiguous segments. Additional information includes local height restrictions applicable to 3D vertical barriers to take into consideration, for example, ground conditions, building restrictions, construction costs, and the like. Height restrictions can apply to an entire 3D vertical barrier or specific segments. Different segments may have different height restrictions. Furthermore, the DST preferably enables users to enter height increments to nominal height coordinates of 3D points of interest above ground level and/or a maximum distance between a pair of 3D points of interest on opposite sides of a vertical barrier which is particularly applicable to designing 3D vertical barriers for protecting against assault means with limited ranges, for example, rifles, RPGs, and the like.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a high level block diagram of a general purpose computer system for supporting 3D line-of-sight (LOS) analysis of vertical barriers in 3D virtual reality environments in accordance with the present invention;

FIG. 2 is a flow diagram of 3D LOS analysis of vertical barriers in a 3D virtual reality environment in accordance with the present invention;

FIG. 3 is a pictorial view of a GUI depicting a hotel with a perimeter wall and 3D lines of sight for two 3D LOS analyses;

FIG. 4 is a table of X, Y and Z Cartesian coordinates for determining the field of view from a 5^{th} floor balcony of the hotel with respect to five 3D points of interest beyond the hotel's perimeter wall;

FIG. 5 is a table of X, Y and Z Cartesian coordinates for determining which of the hotel's floors permit an unobstructed view of a 3D point of interest beyond the hotel's perimeter wall;

FIG. 6 is a pictorial view of a GUI depicting a security wall for protecting vehicles traveling along a road from sniper fire from sniper positions atop buildings in a hostile neighborhood;

FIG. 7 is a graph showing the height of a security wall relative to ground level; and

FIG. 8 is a graph showing quantities of 2 m high segments, 5 m high segments, 6 m segments, and 8 m high segments for constructing a security wall.

### DETAILED DESCRIPTION OF PREFERRED EMBODIMENTS OF THE PRESENT INVENTION

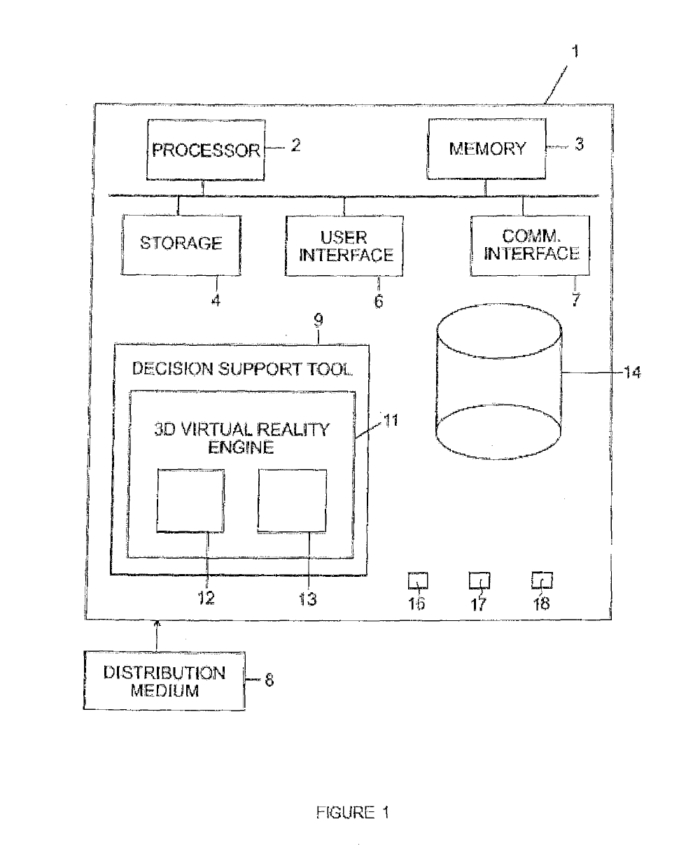

FIG. 1 shows a general purpose computer system 1 including a processor 2, system memory 3, non-volatile storage 4, an operator interface 6 including a keyboard, a mouse, a display, a printer, and the like, and a communication interface 7. The constitution of each of these elements is well known and each performs its conventional function as known in the art and accordingly will not be described in greater detail. In particular, the system memory 3 and the non-volatile storage 4 are employed to store a working copy and a permanent copy of the programming instructions implementing the present invention. The permanent copy of the programming instructions to practice the present invention may be loaded into the non-volatile storage 4 in the factory, or in the field, through communication interface 7, or through distribution medium 8. The permanent copy of the programming instructions is capable of being distributed as a program product in a variety of forms, and the present invention applies equally regardless of the particular type of signal bearing media used to carry out distribution. Examples of such media include recordable type media e.g. CD ROM and transmission type media e.g. digital communication links. Although FIG. 1 is depicted as a general purpose computer system that is programmed to perform various control functions in accordance with the present invention, the present invention can be implemented in hardware, for example, as an application specified integrated circuit (ASIC). As such, the process steps described herein are intended to be broadly interpreted as being equivalently performed by software, hardware, or a combination thereof.

The computer system 1 is capable of running a Decision Support Tool (DST) 9 for 3D LOS analysis of existing or proposed 3D vertical barriers in 3D virtual reality environments. The DST 9 includes a commercial off-the-shelf (COTS) virtual reality engine 11 including a scene graph 12 and a renderer 13. Suitable COTS 3D virtual reality engines 11 include inter alia Vega Prime from MultiGen Paradigm, Inc. (www.multigen.com), Legus 3D commercially available from 3D Software, Inc. (www.Legus3D.com), and the like. The DST 9 interfaces with a geo-database 14 including information required for an application at hand. For example, the geo-database 14 can include inter alia Digital Terrain Model (DTM) files, Geographical Information System (GIS) data, land survey data, civil engineering an/or architectural structure CAD drawings, data extracted from aerial imagery using photogrammetry or other means, and the like.

The DST 9 includes an Input Module 16 for enabling users to input information affecting 3D LOS analysis of existing or proposed 3D vertical barriers. Pertinent information can include whether a 3D vertical barrier is to be considered as a single entity or a series of contiguous segments. In the latter instance, a user can stipulate the number of segments, the start point and end point of each segment, the length of each segment, etc. The DST 9 typically determines different heights for different segments along a 3D vertical barrier. The DST 9 preferably enables users to enter height increments to nominal height coordinates of 3D points of interest above ground level. The DST 9 preferably includes a Height Restriction Module 17 for enabling a user to enter height restrictions pertaining to vertical barriers, for example, to take into consideration ground conditions, building restrictions, cost considerations, and the like, A user may enter different height restrictions for different segments along a 3D vertical barrier. The DST 9 also preferably includes a Maximum Distance Module 18 for enabling a user to enter a maximum distance for a 3D LOS between a pair of 3D points of interest on opposite sides of a 3D vertical barrier for excluding 3D lines of sight due to their actual distance being greater than a predetermined maximum distance.

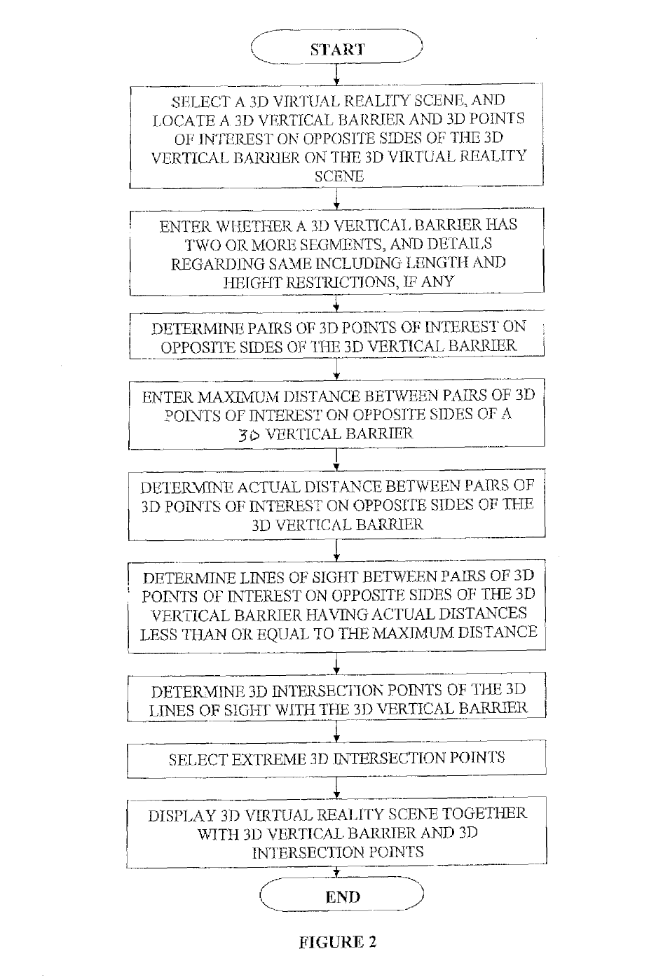

FIG. 2 shows a flow diagram of 3D LOS analysis of a 3D vertical barrier including the steps of selecting a 3D virtual reality scene and locating a 3D vertical barrier and 3D points of interest thereon. Additional steps can include entering whether a 3D vertical barrier is made up of segments and the maximum distance of 3D lines of sight between pairs of 3D points of interest on opposite sides of a 3D vertical barrier. The DST 9 determines the actual distance between pairs of 3D points of interest on opposite sides of a 3D vertical barrier for discarding pairs of 3D points of interest having actual distances longer than the predetermined maximum distance. The DST 9 determines the 3D intersection points between 3D lines of sight and a 3D vertical barrier. The DST 9 can select extreme 3D intersection points for determining an upper boundary and/or a lower boundary of a 3D vertical barrier depending on the application at hand.

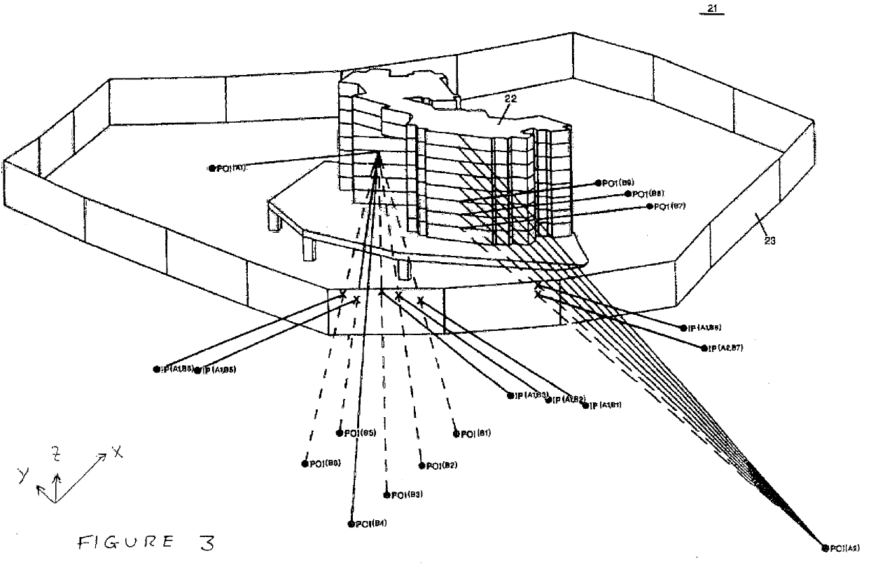

FIG. 3 shows a GUI 21 depicting an 8 storey hotel 22 with an existing 10 m high perimeter wall 23 with two sets of 3D lines of sight for two 3D LOS analyses as follows: First, for determining a 5^{th} floor balcony's field of view denoted POI(A1) with respect to five 3D points of interest denoted POI(B1), POI(B2), POI(B3), POI(B4), POT(B5) and POI(B5) beyond the hotel's perimeter wall 23. And second, for determining which of the hotel's floors permit an unobstructed view of a 3D point of interest denoted POI(A2) beyond the hotel's perimeter wall 23.

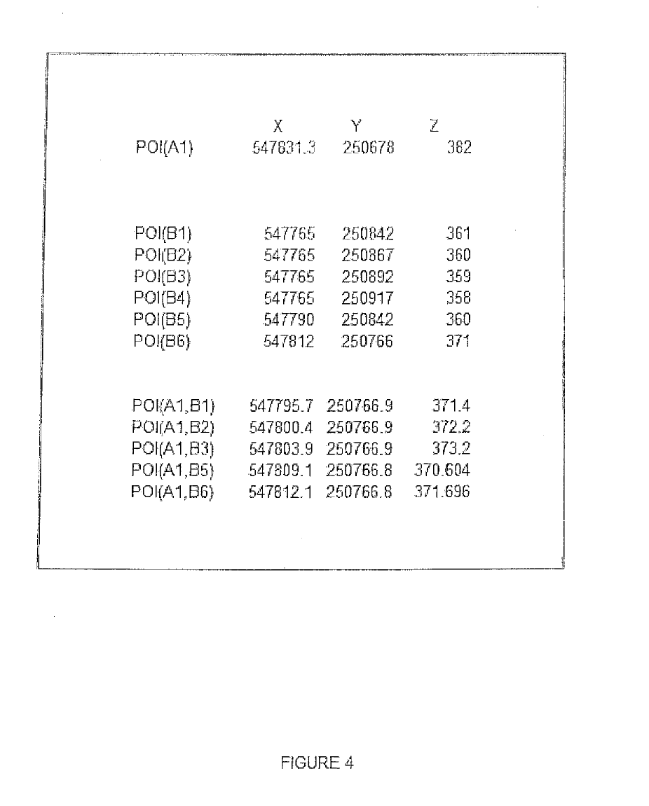

FIG. 3 shows that a 5^{th} floor balcony POI(A1) has a single unobstructed 3D DOS with the furthest 3D point of interest POI(B4) and five obstructed 3D lines of sight with the closer 3D points of interest POI(B1), POI(B2), POI(B3), POI(B5) and POI(B6) which intercept the perimeter wall 23 at intersection points IP(A1,B1), IP(A1,B2), IP(A1,B3), IP(A1,B5) and IP(A1,B6). FIG. 4 shows the XYZ Cartesian coordinates of the 3D points of interest POI(A1), POI(B1), POI(B2), POI(B3), POI(B4), POI(B5) and POI(B6), and the 3D intersection points IP(A1,B1), IP(A1,B2), IP(A1,B3), IP(A1,B5) and IP(A1,B6). This information can be used, for example, for comparing how much the 5^{th} floor balcony's field of view is improved by lowering the perimeter wall 23 by 1 m, 2 m, etc.

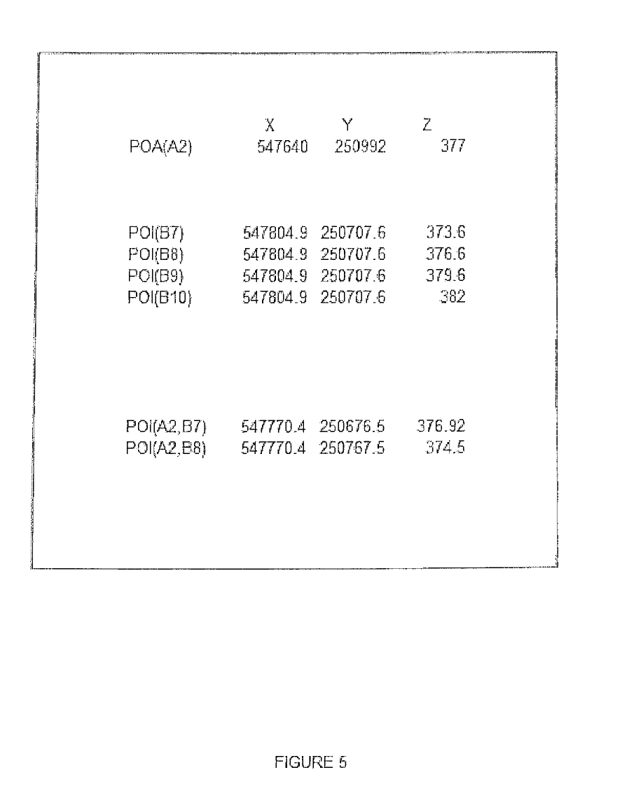

FIG. 3 also shows that a 3D point of interest denoted POI(A2) has obstructed 3D lines of sight with the two hotel's two lower floors denoted POI(B7) and POI(B8) and unobstructed lines of sight with the 3^{rd} floor denoted POI(B9), the 4^{th} floor denoted POI(B10), and upwards. The obstructed 3D lines of sight have 3D intersection points denoted IP(A2,B7), and IP(A2,B8). FIG. 5 shows the XYZ Cartesian coordinates of the 3D points of interest POI(A2), POI(B7), POI(B8), POI(B9), and POI(B10), and the 3D intersection points IP(A2,B7), and IP(A2,B8). This information can be used, for example, for determining by how much the perimeter wall 23 must be lowered such that all the floors have an unobstructed view of the 3D point of interest POI(A2).

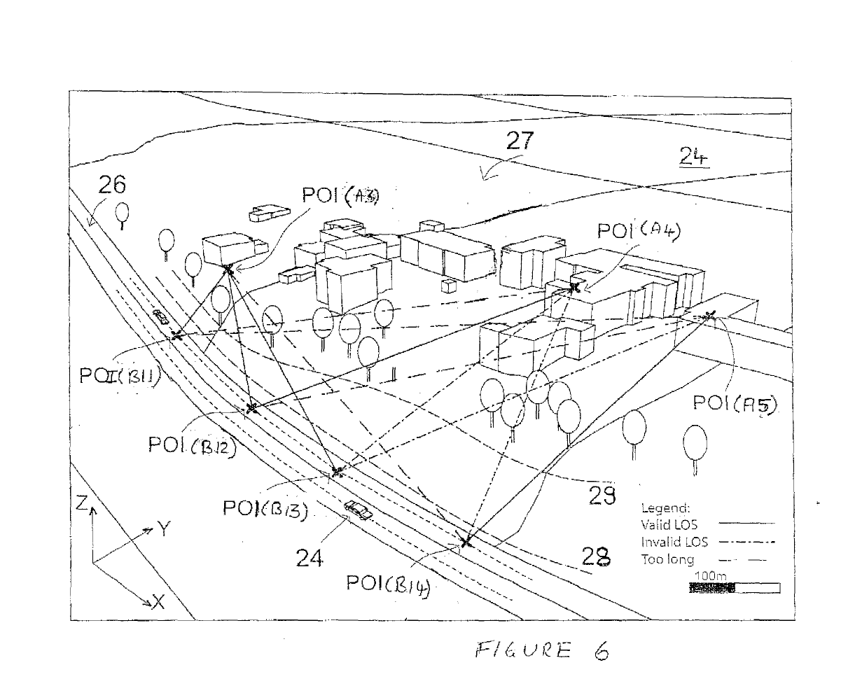

FIG. 6 shows a GUI 24 depicting a road 26 and a hostile neighborhood 27, and a proposed location of a security wall 28 adjacent the road 26 for protecting vehicles traveling therealong from sniper fire from the hostile neighborhood 27. The DST 9 enables the determination of the minimum height of the security wall 28 to obstruct 3D lines of sight from three exemplary sniper positions denoted POT(A3), POI(A4), and POI(A5) from rooftops to four exemplary positions denoted POI(B11), POI(B12), P01(B13), and POI(B14) along the road 26. The highest rooftops are typically selected as sniper positions to ensure that a worst case scenario is simulated thereby affording better protection for vehicles traveling along the road 26 as opposed to, say, sniper positions at ground level.

A user preferably utilizes the Input Module 16 to enter height increments to both the sniper positions POI(A3), POI(A4), and POI(A5) and the positions POI(B11), POI(B12), POI(B13), and POI(B14) to more accurately simulate actual conditions. A user typically adds a 1.5 m height increment to the sniper positions POI(A3), POI(A4), and POI(A5) corresponding to a sniper standing on a rooftop. A user typically adds a 1 m height increment to the positions POI(B11), POI(B12), POI(B13), and POI(B14) corresponding to a driver's height above a road. A user preferably utilizes the Input Module 16 to determine the number of segments making up the security wall 28. Segments can be of the same length or different lengths depending on local topographic conditions, local construction techniques, and the like. A user preferably utilizes the Maximum Distance Module 18 to discard 3D lines of sight between particular sniper positions POI(A3), POI(A4), and POI(A5) and particular positions POI(B11), POI(B12), POI(B13), and POI(B14) which are too long.

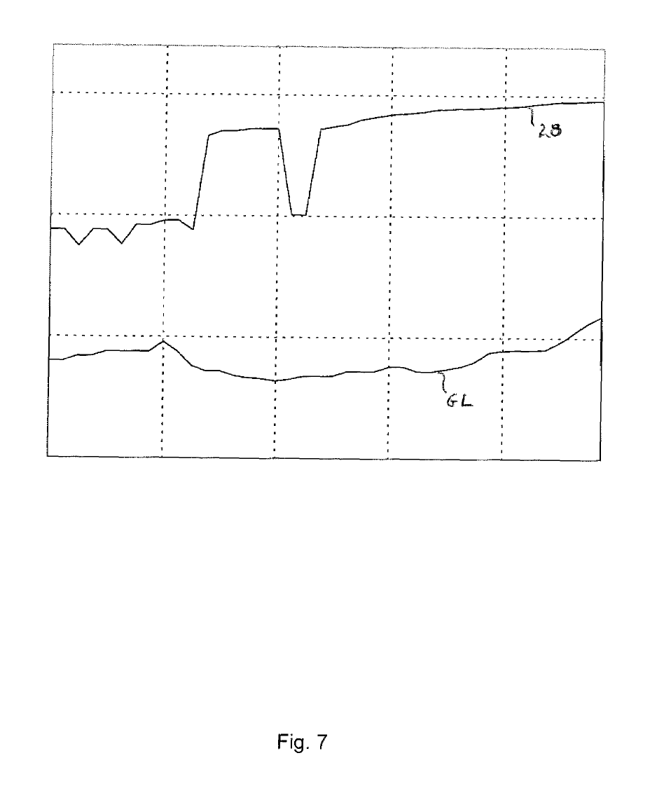

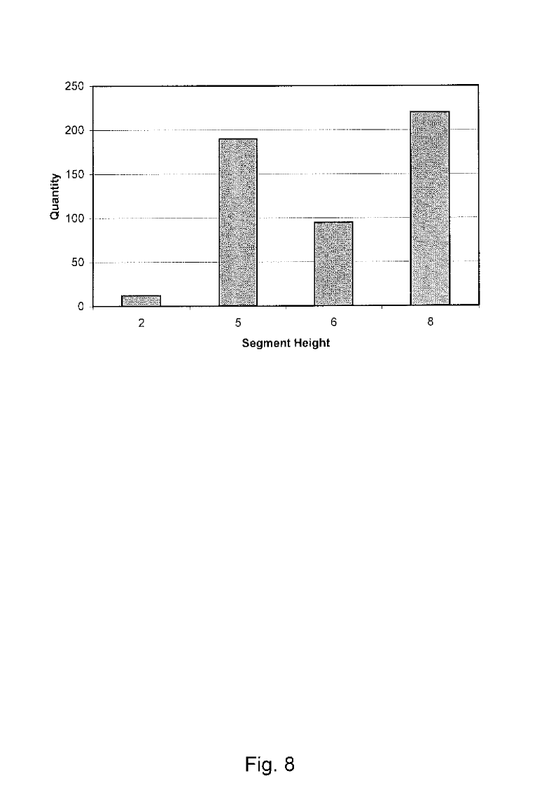

The DST 9 determines the highest 3D interception points along each segment along the proposed location of the security wall 28 to render the minimum height of the security wall 28 to intercept all unobstructed 3D lines of sight between the sniper positions POI(A3), POI(A4), and POI(A5) and the positions POI(B11), POI(B12), POI(B13), and POI(B14), thereby affording complete protection for vehicles traveling along the road 26. The DST 9 preferably outputs a printed report showing the height of a security wall 28 relative to ground level GL (see FIG. 7). The security wall 28 can be made from 2 m long pre-cast concrete segments and the minimum height of each pre-cast concrete segment can also be included in the printed report. The DST 9 can output other reports, for example, the quantities of 2 m high segments, 5 m high segments, 6 m segments, and 8 m high segments for constructing the security wall 28 for assisting in determining construction costs (see FIG. 8).

The DST 9 can output other information pertaining to the design of a security wall 28 as follows: The XYZ Cartesian coordinates of the pairs of 3D points of interest having 3D lines of sight with the highest 3D interception points, and their respective distances from security wall 28. The XYZ Cartesian coordinates of the closet or furthest pairs of 3D points of interest having 3D lines of sight with the highest 3D interception points, and their respective distances from security wall 28. The DST 9 can output statistical information, for example, the total number of 3D lines of sight between all pairs of 3D points of interest on opposite sides of the security wall 28, the total number of unobstructed 3D lines of sight intercepting the security wall 28, and the like.

The DST 9 readily enables a user to compare the security wall 28 with a security wall 29 deployed adjacent the hostile neighborhood 27. Moreover, the DST 9 readily enables a user to enter height restrictions for one or more segments. The DST 9 enables breaches in the protection afforded by one of the security walls 28 or 29 to be displayed in a visually distinguishable manner. The DST 9 enables the affect of the planting of trees to obscure 3D lines of sight from the sniper positions POI(A3), POI(A4), and POI(A5) to the positions POI(B11), POI(B12), POI(B13), and POI(B14).

While the invention has been described with respect to a limited number of embodiments, it will be appreciated that many variations, modifications, and other applications of the invention can be made within the scope of the appended claims.

1. Method for 3D line-of-sight (LOS) analysis of vertical barriers in a 3D virtual reality environment comprising the steps of:
(a) selecting a 3D virtual reality scene;
(b) locating a 3D vertical barrier on the 3D virtual reality scene;
(c) locating at least one 3D point of interest on the 3D virtual reality scene on one side of the 3D vertical barrier;
(d) locating at least one 3D point of interest on the 3D virtual reality scene on the other side of the 3D vertical barrier;
(e) determining lines of sight between pairs of 3D points of interest on opposite sides of the 3D vertical barrier;
(f) determining 3D intersection points between 3D lines of sight with the 3D vertical barrier, if any; and
(g) outputting information regarding the design of the 3D vertical barrier.

2. The method according to claim 1 and further comprising the steps of entering information for determining the start point and end point of each segment of a 3D vertical barrier including at least two segments.

3. The method according to claim 1 and further comprising the step of entering a height increment to increase the height coordinate of a 3D point of interest with respect to its nominal height coordinate on the 3D virtual reality scene.

4. The method according to claim 1 and further comprising the step of entering a height restriction applicable to at least one segment of a 3D vertical barrier including at least two segments.

5. The method according to claim 1 and further comprising the step of entering a maximum distance of a 3D LOS between a pair of 3D points of interest on opposite sides of a 3D vertical barrier for discarding 3D lines of sight having actual distances at least equal to the maximum distance.

6. The method according to claim 1 and further comprising the step of outputting a vertical boundary of a 3D vertical barrier.

7. The method according to claim 1 and further comprising the step of outputting the Cartesian coordinates of the pairs of 3D points of interest on opposite sides of a 3D vertical barrier determining a vertical boundary of the 3D vertical barrier.

8. A computer-readable medium having stored thereon a plurality of instructions, the plurality of instructions including instructions which, when executed by a processor, cause the processor to execute the steps comprising of:
(a) enabling a user to select a 3D virtual reality scene;
(b) enabling a user to locate a 3D vertical barrier on the 3D virtual reality scene;
(c) enabling a user to locate at least one 3D point of interest on the 3D virtual reality scene on one side of the 3D vertical barrier;
(d) enabling a user to locate at least, one 3D point of interest on the 3D virtual reality scene on the other side of the 3D vertical barrier;
(e) determining lines of sight between pairs of 3D points of interest on opposite sides of the 3D vertical barrier;
(f) determining 3D intersection points between 3D lines of sight with the 3D vertical barrier, if any; and
(g) outputting information regarding the design of the 3D vertical barrier.

9. The medium according to claim 8 and further enabling a user to enter information for determining the start point and end point of each segment of a 3D vertical barrier including at least two segments.

10. The medium according to claim 8 and further enabling a user to enter a height increment to increase the height coordinate of a 3D point of interest with respect to its nominal height coordinate on the 3D virtual reality scene.

11. The medium according to claim 8 and further enabling a user to enter a height restriction applicable to at least one segment of a 3D vertical barrier including at least one segment.

12. The medium according to claim 8 and further enabling a user to enter a maximum distance of a 3D LOS between a pair of 3D points of interest on opposite sides of a 3D vertical barrier for discarding 3D lines of sight having actual distances at least equal to the maximum distance.

13. The medium according to claim 8 and further comprising the step of outputting a vertical boundary of a 3D vertical barrier.

14. The medium according to claim 8 and further comprising the step of outputting the Cartesian coordinates of the pairs of 3D points of interest on opposite sides of a 3D vertical barrier determining a vertical boundary of the 3D vertical barrier.

15. Apparatus for 3D line-of-sight (LOS) analysis of vertical barriers in a 3D virtual reality environment comprising:
(a) means for selecting a 3D virtual reality scene;
(b) means for locating a 3D vertical barrier on the 3D virtual reality scene;
(c) means for locating at least one point of interest on the 3D virtual reality scene on one side of the 3D vertical barrier;
(d) means for locating at least one point of interest on the 3D virtual reality scene on the other side of the 3D vertical barrier;
(e) means for determining lines of sight between pairs of points of interest on opposite sides of the 3D vertical barrier;
(f) means for determining intersection points between lines of sight with the 3D vertical barrier, if any; and
(g) means for outputting information regarding the design of the 3D vertical barrier.

16. The apparatus according to claim 15 and further comprising means for entering information for determining the start point and end point of each segment of a 3D vertical barrier including at least two segments.

17. The apparatus according to claim 15 and further comprising means for entering a height increment to increase the height coordinate of a point of interest with respect to its nominal height coordinate on the 3D virtual reality scene.

18. The apparatus according to claim 15 and further comprising means for entering a height restriction applicable to at least one segment of a 3D vertical barrier including at least one segment.

19. The apparatus according to claim 15 and further comprising means for entering a maximum distance of a 3D LOS between a pair of 3D points of interest on opposite sides of a 3D vertical barrier for discarding 3D lines of sight having actual distances at least equal to the maximum distance.

20. The apparatus according to claim 15 and further comprising means for outputting a vertical boundary of a 3D vertical barrier.

21. The apparatus according to claim 15 and further comprising means for outputting the Cartesian coordinates of the pairs of 3D points of interest on opposite sides of a 3D vertical barrier determining a vertical boundary of the 3D vertical barrier.
